(19) United States
(12) Patent Application Publication
(10) Pub. No.: US 2026/0366436 A1
(43) Pub. Date: Nov. 19, 2026

(54) MONITORING OF THE PARTICLES OF A TURBINE ENGINE

(71) Applicant: Safran Aircraft Engines, PARIS (FR)

(72) Inventors: Jacques AURIOL, MOISSY-CRAMAYEL (FR); Clément Georges Henri GORCE, MOISSY-CRAMAYEL (FR)

(73) Assignee: Safran Aircraft Engines, PARIS (FR)

(21) Appl. No.: 19/133,523

(22) PCT Filed: Nov. 28, 2023
(86) PCT No.: PCT/FR2023/051860

§ 371 Date: Jun. 18, 2025

(30) Foreign Application Priority Data
Nov. 28, 2022 (FR) FR2212391

(51) Int. Cl. F01D 25/18; F01D 15/10; F01D 21/00

(52) U.S. Cl. CPC F01D 25/18; F01D 15/10; F01D 21/00; F05D 2220/323; F05D 2230/72; F05D 2260/98

(57) ABSTRACT

The present invention relates to a method for monitoring a turbine engine (1), the turbine engine (1) comprising: -at least one rotating shaft (6, 7, 8) which is supported by at least one bearing (12a, 12b, 12c, 13a, 13b, 13c);—at least one electric machine (M1, M2) which is configured to supply electrical energy to the turbine engine (1), the electric machine (M1, M2) comprising at least one roller bearing (23); the electric machine (M1, M2) and the bearing (12a, 12b, 12c, 13a, 13b, 13c) being arranged in a lubrication enclosure (A1, A2); and—a lubrication system (S) which is suitable for lubricating the bearing (12a, 12b, 12c, 13a, 13b, 13c) and the roller bearing (23) and for recovering the oil present in the enclosure (A1, A2), the lubrication system (S) comprising a particle detector (104) which is suitable for counting particles present in the lubrication system (S), the method comprising, after a period A following the electric machine stopping and when an oil flow rate circulating in the lubrication system is greater than a given threshold (B), the following steps:—stopping, for a period T1, the electric machine so as to release particles from the roller bearing (23) so that they circulate in the lubrication system;—counting the particles circulating in the lubrication system for a period T2; and—triggering a maintenance alert for the electric machine when the number of particles counted is greater than a threshold.

### TECHNICAL FIELD

The present application relates generally to the field of turbomachines, and more particularly to the monitoring of a turbomachine equipped with a sensor designed to retain metal particles entrained by the lubricating oil resulting from bearings.

### PRIOR ART

A turbomachine conventionally has rotating parts driven by shafts supported by bearings. These bearings ensure that the shafts rotate correctly and are lubricated by means of a lubrication circuit operating in a closed loop. Bearings are subject to wear phenomena, which results in the appearance of particles of varying sizes in the lubrication circuit. To monitor bearing wear, a particle sensor is installed in the lubrication circuit, in order to prevent engine failure. To meet energy requirements, a turbomachine includes one or more electrical machines to supply electricity and, in particular, to drive the high-pressure shaft. These electrical machines also have bearings that must be lubricated and monitored in the same way as those supporting the rotating shafts.

### DISCLOSURE OF THE INVENTION

Climate change is a major concern for many legislative and regulatory bodies around the world. Indeed, various restrictions on carbon emissions have been, are being or will be adopted by various states. In particular, an ambitious standard applies both to new types of aircraft and to those currently in circulation, requiring the implementation of technological solutions to bring them into line with current regulations. Civil aviation has now been working for several years to make its contribution to the fight against climate change.

Technological research efforts have already enabled significant improvements in the environmental performance of aircraft. The Applicant takes into account the impacting factors in all phases of design and development in order to obtain aeronautical components and products that consume less energy, are more environmentally friendly and whose integration and use in civil aviation has a moderate environmental impact, with the aim of improving aircraft energy efficiency.

As a result, the Applicant is constantly working to reduce its impact on the climate by using virtuous development and manufacturing methods and processes that minimise greenhouse gas emissions as much as possible in order to reduce the environmental footprint of its activities.

This sustained research and development work is focused on new generations of aircraft engines, making aircraft lighter, in particular through the materials used and lighter on-board equipment, developing the use of electrical technologies for propulsion, and, as an essential complement to technological progress, aeronautical biofuels.

The present application is the result of technological research aimed at very significantly improving aircraft performance and, in this sense, contributes to reducing the environmental impact of aircraft.

In particular, one aim of the present application is to monitor a turbomachine comprising at least one electrical machine preferably incorporated inside the turbomachine as close as possible to the shafts.

The electrical machine is incorporated inside the turbomachine instead of the nacelle, which is limited in size.

The invention makes it possible to use electrical machines, given the growing need for electricity. More specifically, electric power is cleaner and easier to maintain.

To this end, a first aspect of the invention relates to a method for monitoring a turbomachine, the turbomachine comprising: at least one rotating shaft supported by at least one bearing; at least one electrical machine configured to supply electrical power to the turbomachine, the electrical machine comprising at least one roller bearing; the electrical machine and the bearing being disposed in a lubrication enclosure; a lubrication system suitable for lubricating the bearing and the roller bearing and for recovering the oil present in the enclosure, the lubrication system comprising a particle detector suitable for counting particles present in the lubrication system, the method comprising, after a period A following a stoppage of the electrical machine, the following steps:
a) stopping, for a period T1, of the electrical machine so as to release particles originating from the roller bearing in order that they circulate in the lubrication system;
b) counting particles circulant in the lubrication system for a period T2;
c) triggering a maintenance alert of the electrical machine when the number of particles counted is greater than a threshold.

The method according to the first aspect is advantageously supplemented by the following features, taken individually or in any of the possible technical combinations thereof:
the steps a), b) and c) are implemented when a flow rate of oil circulating in the lubrication system is greater than a given threshold (B);
the turbomachine comprises a first electrical machine and a second electrical machine, the first electrical machine being stopped, the method comprising a reconfiguration of the second electrical machine in such a way that the second electrical machine supplies electrical power instead of the stopped first electrical machine;
the electrical machine is based on wound technology without permanent magnets capable of attracting particles;
the electrical machine is configured to convert a torque from a rotating shaft into electrical power;
each step of stopping the electrical machine is implemented at the end of the period A, between a period equivalent to 1 flight and 50 flights of the turbomachine 1;
the method comprises authorising the take up of the torque by the electrical machine after the period T2 has elapsed;
period T1 is between 0.1 seconds and 90 seconds, inclusive;
period T2 is between 1 second and 10 minutes, inclusive.

In a second aspect, the invention also relates to a turbomachine comprising: at least one rotating shaft supported by at least one bearing; at least one electrical machine configured to supply electrical power to the turbomachine, the electrical machine comprising at least one roller bearing; the electrical machine and the bearing being disposed in a lubrication enclosure; a lubrication system suitable for lubricating the bearing and the roller bearing and for recovering the oil present in the enclosure, the lubrication system comprising a particle detector suitable for counting particles present in the lubrication system, the turbomachine comprising a processing unit connected to said detector and configured to implement a method for monitoring the turbomachine according to the first aspect.

In a third aspect, the invention relates to an aircraft comprising at least one turbomachine according to the second aspect.

### DESCRIPTION OF THE FIGURES

Other features, aims and advantages of the invention will emerge from the following description, which is given purely by way of illustration and not being limiting and which should be read with reference to the attached drawings, in which:

FIG. 1 illustrates an aircraft comprising a turbomachine in accordance with the present application;

FIG. 2 illustrates a turbomachine in accordance with the present application;

FIG. 3 illustrates steps of a monitoring method according to the present application.

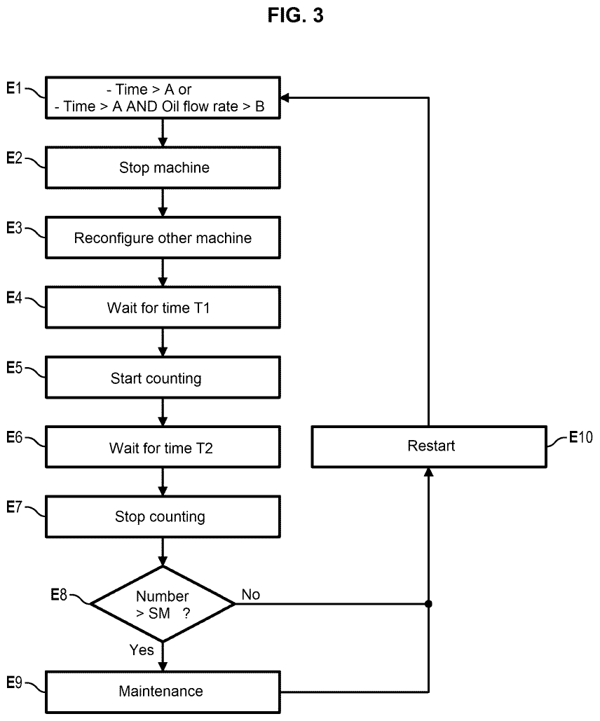

In all figures, similar elements have identical reference signs.

### DETAILED DESCRIPTION OF THE INVENTION

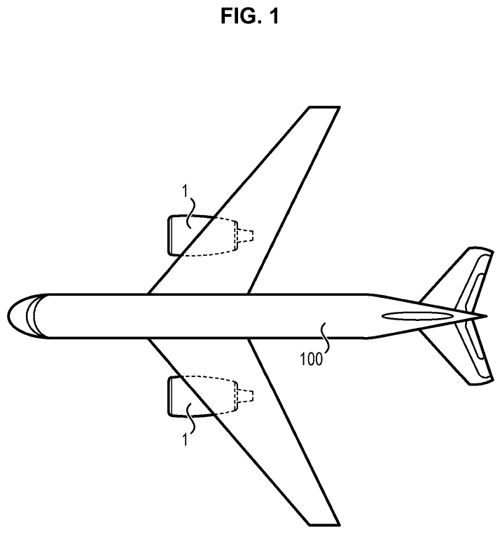

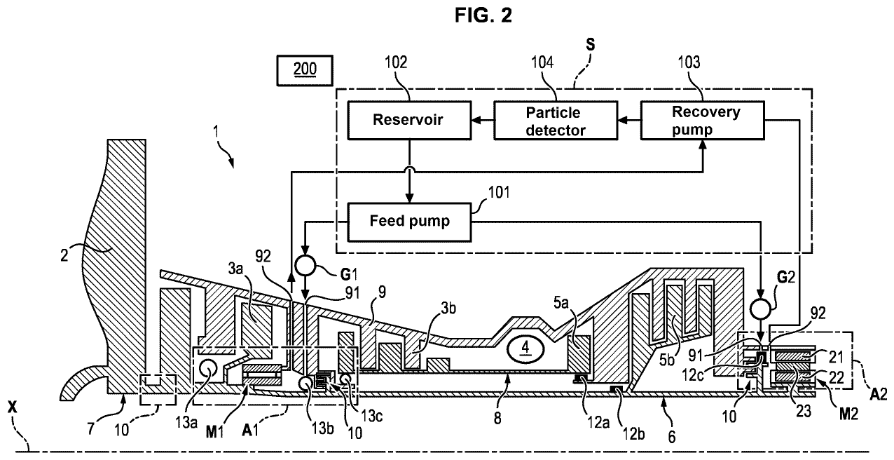

FIG. 1 illustrates an aircraft 100 comprising two turbomachines 1 and FIG. 2 schematically illustrates a turbomachine 1. The turbomachine 1 has a main direction extending along a longitudinal axis X and comprises, from upstream to downstream in the direction of gas flow, a fan 2, a low-pressure compressor 3a, a high-pressure compressor 3b, a combustion chamber 4, a high-pressure turbine 5a, a low-pressure turbine 5b, and a gas exhaust nozzle (not shown).

The high-pressure turbine 5a rotates the high-pressure compressor 5a by means of a first shaft 8, known as the high-pressure shaft, while the low-pressure turbine 5b rotates low-pressure compressor 3a and the fan 2 by means of a second shaft 6, known as the low-pressure shaft. The low-pressure shaft 6 is generally housed inside the high-pressure shaft 7. Advantageously, the fan 2 is rotated by the low-pressure shaft 6 by means of a geared reduction mechanism 10 and a third shaft, known as the fan shaft 7, which is fixed between the reduction mechanism 10 and the fan 2. The reduction mechanism 10 makes it possible to have a large-diameter fan 2 and at the same time a low-pressure compressor 3a and a low-pressure turbine 5b operating at high speed.

The fan shaft 7, the high-pressure shaft 8 and the low-pressure shaft 6 are centred on the axis X of the turbomachine 1 via a series of bearings.

In particular, the high-pressure shaft 7 and the low-pressure shaft 6 are fixed to a casing 9 of the turbomachine 1 by means of bearings 12a, 12b, 12c, 13a, 13b, 13c. The bearings designated by the reference signs 12a, 12b, 12c are arranged at the rear of the turbomachine 1 while the bearings 13a, 13b, 13c are arranged at the front of the turbomachine 1. The fan shaft 7 is also supported by a structural part, by means of bearings that are not shown.

In order to lubricate the various bearings 12a, 12b, 12c, 13a, 13b, 13c, the turbomachine 1 comprises a lubrication system S, supplying a closed oil circuit, and enclosures A1, A2 in which the bearings 12a, 12b, 12c, 13a, 13b, 13c are housed. These enclosures A1, A2 define sealed environments in which a jet of oil is injected onto the bearings. The bearings 12a, 12b, 12c, 13a, 13b, 13c are lubricated and cooled by oil which is sprayed into the enclosure via nozzles G1, G2 (at a pressure of between 2 and 10 bar, for example).

The lubrication system S comprises a feed pump 101 which pumps oil from an oil reservoir 102 to be delivered to the bearings 12a, 12b, 12c, 13a, 13b, 13c housed in the enclosures A1, A2 through ducts 91 formed in the housing 9. During operation, the lubricating oil is centrifuged by the bearings and accumulates at the low point of the enclosure A1, A2. To prevent the oil escaping from the enclosure E1, E2, dynamic seals 10 are provided, for example labyrinth seals or servo-controlled radial seals (SRS). The lubrication system S is a closed circuit because the oil is limited in quantity. As a result, the centrifuged oil is recovered by recovery pumps 103 which can recycle the recovered oil. One oil recovery pump 103 is provided per enclosure A1, A2 in order to evacuate a volume of oil equivalent to that injected into the enclosure. The pumps 103 pump the oil from ducts 92 formed in the casing 9. It should be noted that centrifuged oil can create an oil cloud/mist in the enclosure.

To detect wear on the bearings, a particle detector 104 is disposed in the oil circuit before the recovered oil is reinjected into the reservoir 101. Such a particle detector 104 is, for example, an electromagnetic sensor configured to collect particles present in the lubrication system. Such a detector is connected to a processing unit 200 of the turbomachine, which analyses the signal resulting from the detector in order to count the particles.

As indicated in the introduction, the turbomachine 1 comprises one or more electrical machines M1, M2 for supplying electrical power to the turbomachine 1. An electrical machine M1, M2 takes up torque from a shaft of the turbomachine, for example, and converts it into electrical power to supply power to the turbomachine 1 (to accessories, for example).

An electrical machine M1, M2 typically comprises a stator 21, a rotor 22, and a roller bearing 23 (or bearing) to minimise the air gap between the rotor 22 and the stator 21. To enable the roller bearing 23 of the electrical machine M1, M2 to be lubricated, the electrical machine is disposed in an oil enclosure A1, A2 in order to take advantage of the oil provided for the bearings supporting the shafts of the turbomachine 1 as described above. Here again, the accumulated oil from the roller bearings 23 of the electrical machine M1, M2 is also centrifuged to accumulate at the low point of the enclosure A1, A2.

As shown in FIG. 2, two electrical machines M1, M2 are disposed, each in an oil enclosure A1, A2. Of course, a different number of electrical machines is possible.

It has been observed that, in operation, the electrical machine M1, M2 emits a magnetic field which retains particles resulting from wear of its roller bearings and can potentially, in operation, attract magnetic particles resulting from wear on the bearings housed in the enclosure. Advantageously, the electrical machine is based on wound technology without permanent magnets capable of attracting particles in addition to the magnetic field.

Retained particles can damage the electrical machine M1, M2 per se, but can also interfere with the monitoring of the bearings, since these particles are not counted.

In order to monitor the turbomachine, taking into account the presence of electrical machines, a monitoring process as described below is implemented.

The electrical machine M1, M2 to be monitored is stopped after a certain period A has elapsed following a previous stoppage also intended for its monitoring and advantageously when the oil flow rate in the lubrication system is greater than a threshold B (steps E1, E2). These two conditions must be met simultaneously if applicable. In the description given here, it is assumed that the machine M1 is stopped. The oil flow rate B is set on the test bench and is selected so that it can be obtained during a flight phase. A flight phase of interest is, for example, take-off. In addition, the oil flow rate B ensures that detection necessarily takes place at a time when the particles are correctly conveyed by the oil flow (this is not the case, for example, when the turbomachine is operating at idle speed), and this flow rate must be low enough to ensure that it is achieved whatever the flight.

The period A between each stoppage of the electrical machine M1 is also defined by tests and depends on the rate of degradation of the bearings. Such a time corresponds to 1 to 50 flights of the turbomachine 1.

In a complementary manner, when an electrical machine M1 is stopped, another electrical machine M2 present in the turbomachine 1 can then be reconfigured to take over from the one which is stopped (step E3), in such a way that the operation of the turbomachine is not impacted and electrical power is always supplied. Alternatively, an external source, for example a battery, can take over from the stopped electrical machine.

After a period T1 has elapsed (step E4) following the stopping of the electrical machine M1, the counting of the particles starts (step E5). Such a period T1 is also set on the test bench and avoids counting between the moment when the particles are released and the moment when the fastest particles reach the particle detector. This time takes into account the speed at which the particles move in the oil stream at a flow rate greater than the value B. Of course, the time will depend on the flow rate B. The period T1 may be between 100 ms and 90 seconds, inclusive. By way of example, considering a pipe length of between 1 m and 10 m and a flow rate of between 10,000 L/h and 200 L/h through a pipe of between 0.75 inch and 1 inch, we obtain a range of between 0.1 s and 90 seconds.

The particles are counted for a period T2 (step E6). Such a period T2 is, for example, between 1 second and 10 minutes, inclusive. By way of example, considering a transport efficiency of 0.25, and rounding off, T2=1 s to 6 minutes is obtained. This period T2 takes account of the speed of the slowest particles that the electrical machine M1 can still release to ensure that they reach the particle detector 104. At the end of this period T2, particle counting stops (step E7). Period T2 therefore sets a counting window so that a large quantity of particles can be counted (from the fastest to the slowest). Stopping the electrical machine in the enclosure enables the particles from the shaft bearings and the roller bearings of the electrical machine to circulate well in the lubrication system.

The detection of particles originating from the bearings of the electrical machine is implemented by considering that any particle detected between T1 and T2 is a particle originating from the electrical machine. More specifically, statistically, the probability of a particle originating from the bearings of the turbomachine being released during this window is negligible compared with the overall observation period, which means that the source of particle emission can be reliably located.

In this way, it is possible to determine the quantity of particles originating from the electrical machine.

The number of particles counted is compared with a maintenance threshold SM (step E8) and if this number is greater than this threshold then a maintenance alert is generated (step E9). Otherwise, if the number is below this threshold, the electrical machine is restarted (step E10) so that it can be authorised to take up a torque.

It should be noted that such an alert may take the form of an alert to a user, for example a visual alert, etc. The electrical machine which had been stopped is then restarted (step E10), the user being warned of maintenance and being able to restart. In particular, the electrical machine is again authorised to take up torque in order to transform it into electrical power.

1. A method for monitoring a turbomachine,
the turbomachine comprising:
at least one rotating shaft supported by at least one bearing;
at least one electrical machine configured to supply electrical power to the turbomachine, the electrical machine comprising at least one roller bearing; the electrical machine and the bearing being arranged in a lubrication enclosure;
a lubrication system configured for lubricating the bearing and the roller bearing and configured for recovering the oil present in the enclosure, the lubrication system comprising a particle detector suitable for counting particles present in the lubrication system,
the method comprising, after a period A following the electrical machine stopping, the following steps:
a) stopping, for a period T1, of the electrical machine so as to release particles originating from the roller bearing in order that they circulate in the lubrication system;
b) counting particles circulating in the lubrication system for a period T2;
c) triggering a maintenance alert of the electrical machine when the number of particles counted is greater than a threshold.

2. The method of claim 1, wherein the steps a), b) and c) are implemented when a flow rate of oil circulating in the lubrication system is greater than a given threshold.

3. The method of claim 1, the turbomachine comprising a first electrical machine and a second electrical machine, wherein the first electrical machine being stopped, the method comprising a reconfiguration of the second electrical machine in so that the second electrical machine supplies electrical power instead of the stopped first electrical machine.

4. The method of claim 1, wherein the electrical machine is based on wound technology, without permanent magnets capable of attracting particles.

5. The method of claim 1, wherein the electrical machine is configured to convert a torque from a rotating shaft into electrical power.

6. The method of claim 1, wherein each step of stopping the electrical machine is implemented at the end of the period A, between a period equivalent to 1 flight and 50 flights of the turbomachine.

7. The method of claim 1, comprising authorising the take up of the torque by the electrical machine after the period T2 has elapsed.

8. The method of claim 1, wherein the period T1 is between 0.1 seconds and 90 seconds, inclusive.

9. The method of claim 1, wherein the period T2 is between 1 second and 10 minutes, inclusive.

10. A turbomachine comprising at least one rotating shaft supported by at least one bearing, at least one electrical machine configured to supply electrical power to the turbomachine, the electrical machine comprising at least one roller bearing; the electrical machine and the bearing being disposed in a lubrication enclosure; a lubrication system suitable for lubricating the bearing and the roller bearing and for recovering the oil present in the enclosure, the lubrication system comprising a particle detector suitable for counting particles present in the lubrication system, the turbomachine comprising a processing unit connected to said detector and configured to implement a method for monitoring the turbomachine of claim 1.

11. An aircraft comprising a turbomachine of claim 10.
